(19) United States
(12) Patent Application Publication
(10) Pub. No.: US 2009/0091127 A1
(43) Pub. Date: Apr. 9, 2009

(54) Saddle end cap

(76) Inventors: L. Herbert King, JR., Chesterfield, MO (US); James Keeven, O'Fallon, MO (US)

Correspondence Address: Carl L. Johnson;Jacobson and Johnson, Suite 285, One West Water Street, St. Paul, MN, 55107-2080, US

(21) Appl. No.: 11/973,026

(22) Filed: Oct. 9, 2007

(51) Int. Cl. F16L 55/00

(52) U.S. Cl. 285/197

(57) ABSTRACT

A dual mode pipe insert having a first mode wherein a set of sealing ribs located thereon provide for retention of the dual pipe insert as a stand alone saddle end cap and a second mode wherein an internal pipe insert port, which is located intermediate a set of sealing ribs, cooperates with an external saddle support having an alignment guide and latch mechanism for securing a pipe saddle housing in a branch pipe connecting position to enable blind formation of a branch pipe through the pipe insert and proximate an end of a capped pipe

### FIELD OF THE INVENTION

This invention relates generally to pipe inserts and, more specifically, to a pipe insert comprising a saddle end cap that can either be used in a first mode as a stand alone end cap or in a second mode in conjunction with a pipe saddle to enable one to form a blind branch attachment proximate the end of a pipe.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

The art on pipe saddle and branch attachment to irrigation pipes is replete with numerous devices including a saddle for attachment to the irrigation pipe for forming a branch attachment to the irrigation pipe as shown in U.S. Pat. No. 6,767,033. A one-piece saddle tee and coupling tap such as shown in U.S. Pat. No. 5,694,972. A tap and saddle for forming a hinged coupon that can be left in the irrigation pipe as shown in U.S. Pat. No. 6,510,865. A two-step branch forming attachment as shown in U.S. Pat. No. 5,105,844, which shows both the saddle and the tap that forms the branch attachment. Another type of pipe saddle is shown in U.S. Pat. No. 6,767,033, which includes a flexible tooth in a latching hub for forming engagement with the teeth on a flexible band. While a locking end cap is shown the end cap is locked in place by formation of a branch attachment to the irrigation pipe. Often times a decision on whether to include a branch attachment on an irrigation pipe is made on the go and after a pipe has been capped which can require removing and replacing an end cap.

### SUMMARY OF THE INVENTION

A dual mode pipe insert having a first mode wherein a set of sealing ribs located thereon provide for retention of the dual mode pipe insert as a stand alone saddle end cap and a second mode wherein an internal pipe insert port, which is located intermediate a set of sealing ribs, cooperates with an external saddle support having an alignment guide and latch mechanism for securing a pipe saddle housing in a branch pipe connecting position to enable blind formation of a branch pipe through the capped pipe and proximate an end of a capped pipe.

### BRIEF DESCRIPTION OF THE DRAWINGS

FIG. 1 is a top view of a pipe insert comprising a saddle end cap for engagement with an open end on a pipe and a saddle support thereon to permit forming a branch line proximate the end of the pipe;

FIG. 2 is an exploded perspective view showing the saddle end cap of FIG. 1 about to be inserted into a pipe;

FIG. 3 is a perspective showing the saddle end cap of FIG. 2 inserted into the end of the pipe of FIG. 2;

FIG. 4 shows a side view a pipe saddle for attachment to an exterior of a pipe;

FIG. 4A is a sectional view of the pipe saddle of FIG. 4 showing the threads in the pipe saddle and the latching hub of the pipe saddle;

FIG. 4B is an enlarged sectional view shown the teeth on the flexible band of the pipe saddle of FIG. 4 in engagement with the teeth in the latching hub of FIG. 4;

FIG. 5 shows a perspective view the pipe saddle of FIG. 4 about to be placed around an exterior surface of the pipe of FIG. 2;

FIG. 6 shows a top view of the pipe saddle of FIG. 4 held in an axially slideable condition on the pipe;

FIG. 7 shows the pipe saddle of FIG. 6 after the pipe saddle has been slid into the saddle support position for formation of a branch pipe; and

FIG. 8 shows a tap for forming a branch attachment to a pipe and for forming locking engagement with the saddle end cap.

### DESCRIPTION OF THE PREFERRED EMBODIMENT

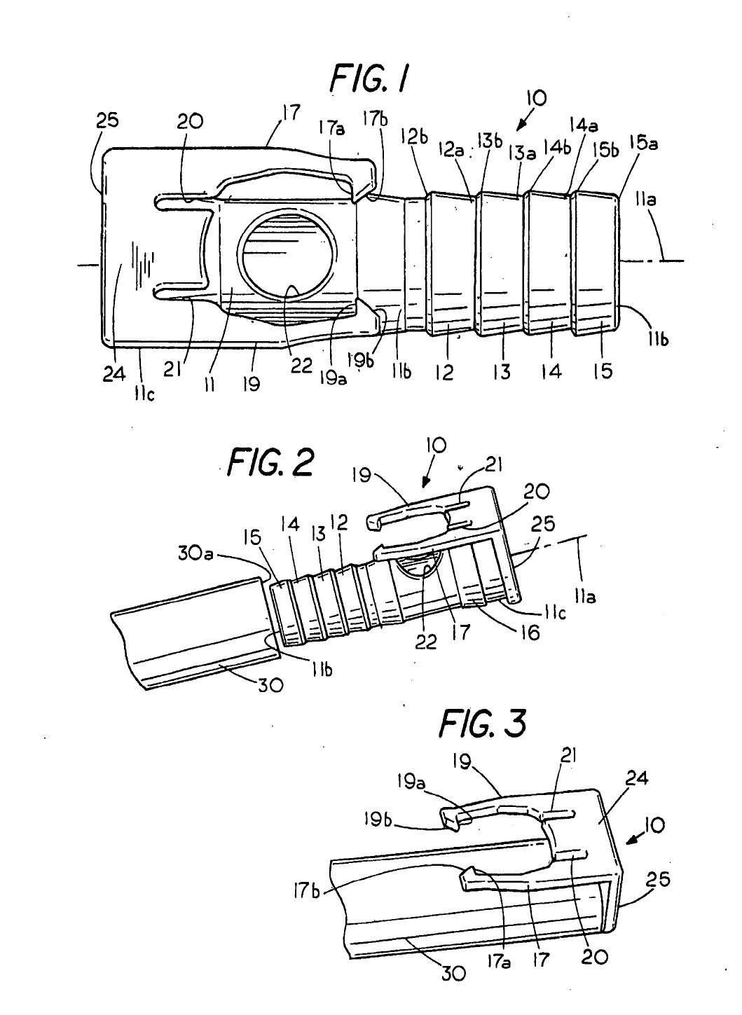

FIG. 1 is a top view of a dual mode pipe insert 10 for use in one mode as a one-piece saddle end cap that blocks an open end on a pipe such as an irrigation pipe and in a second mode for locking a pipe saddle thereto to permit blind formation of a branch line proximate the end of the pipe with the pipe saddle and pipe insert held in fluid tight engagement with each other by a tap. The dual mode pipe insert or saddle end cap 10 is frictionally held in a pipe, such as a polyethylene irrigation pipe, although other pipes can also be used with the saddle end cap 10. Saddle end cap 10 comprises a rigid annular cylindrical housing or tube 11 having a central axis 11a. Located on the exterior cylindrical surface of housing 11 are a plurality of circumferential tapered sealing ribs, 12, 13, 14, 15 and 16 (FIG. 2) which are concentrically positioned and axially spaced along the exterior surface 11b of the housing 11. Each of the tapered sealing ribs 12, 13, 14, 15 and 16 are identical and only one is described herein. Sealing rib 12 includes a maximum diameter section 12b, which tapers downward in an axial direction to a minimum diameter section 12a. The maximum diameter 12b is large enough to form an interference fit and therefore circumferential sealing engagement with an interior surface of a pipe to prevent fluid leaking past the engaged region of the sealing rib section 12b and the inner surface of pipe 30. The external minimum diameter 15a is generally less than the inside diameter of the pipe 30 to facilitate insertion of the saddle end cap into a pipe to be sealed. In use the sealing rib 12b frictionally retains the saddle end cap 10 in a pipe such as an irrigation pipe when the fluid in the pipe is under pressure. Since each of the plurality of sealing ribs 12, 13, 14, 15 and 16 contain identical maximum and minimum diameter sections to facilitate spaced concentric interference contact between the sealing ribs and the inside of the pipe they are not described herein.

Saddle end cap 10 is typically made from a polymer plastic which is sufficiently harder than the pipe into which it is inserted with the pipe general made from polyethylene tubing or PVC tubing although other types of pipes and tubing can be sealed with saddle end cap 10. The relative stiffness or hardness of saddle end cap 10 with respect to the pipe permits the saddle end cap to be axially forced into an interference fit with the interior surface of the irrigation pipe by merely applying a force on the closed end of the saddle end cap 10. For example, by tapping the saddle end cap 10 with a mallet one can drive the saddle end cap 10 into the engaged position with pipe 30 as shown in FIG. 3. In the assembled condition, as shown in FIG. 3, the sealing ribs not only retain the saddle end cap 10 on the end of pipe 30 but also block the end of the pipe to prevent leakage from the pipe 30.

FIG. 2 shows that saddle end cap 10 has a first end with an inlet 11b therein and an opposite end which is blocked by an end member 25 to prevent axial internal flow through saddle end cap 10. With each of sealing ribs 12, 13, 14 and 15 having a maximum diameter that is large enough to form both an interference fit and sealing engagement with an interior surface of a pipe the sealing ribs coact to provide a series of barriers to prevent escape of fluid from between the exterior cylindrical surface of the saddle end cap 10 and an internal cylindrical surface of the pipe 30 when the saddle end cap is in engagement with the pipe 30 as shown in FIG. 3 to thereby provide a stand alone saddle end cap.

FIG. 1 shows that saddle end cap 10 includes an integral side port 22 located in rigid housing 11 with the side port 22 located between a first sealing rib 12 of the plurality of tapered sealing ribs, 12, 13, 14 and 15 and an end-sealing rib 16 (see FIG. 2). Thus, sealing rib 16 forms a seal to prevent leakage past pipe end 30a. Located on saddle end cap 10 is an end member 25 for forming an end closure or cap on a second end of the rigid housing 11 with the end member 25 extending radially outward from the housing 11 to engage a saddle support 24 that is cantilevered from end member 25. The saddle support 24 comprises a flat platform that extends along and substantially parallel to the central axis 11a of rigid housing 11 although other shapes could also be used. Saddle support 24 includes a U-shaped first saddle guide 20 located on one side of platform 24 and a second U-shaped saddle guide 21 located in the opposite side of saddle support 24 with each of the saddle guides located parallel to each other. While saddle guides 20 and 21, which are used to hold and align a pipe housing, are shown as U-shaped other shapes of saddle guides can also be used to hold and align a pipe saddle therein. Saddle support 24 also includes an integral resilient latch arm 18 extending longitudinally from a first side of the saddle support 24 and a further resilient latch arm 19 extending longitudinally from a second side of saddle support 24 with the resilient latch arm 17 and said further resilient latch arm 19 laterally yieldable to allow insertion and latched securement of a pipe saddle therein.

FIG. 1 shows the resilient latch arm 17 and the further resilient latch arm 19 are positioned proximate side port 22 to thereby position and hold a pipe saddle in alignment with side port 22 when secured thereto by the resilient latch arm 17 and the further resilient latch arm 19. Latch arm 17 includes a lip 17a for engaging one side of a saddle and similarly latch arm 19 includes a lip 19a for engaging an opposite side of a saddle to retain the saddle in the end cap 10. To facilitate engagement between the saddle and the latch arms latch arm 19 includes an angled guide surface 19b and latch arm 17 includes an angled guide surface 17b so that the sliding of a pipe saddle into contact with the latch arm causes the latch arms 17 and 19 to diverge to allow passage of the pipe saddle into the region between latch arms 17 and 19. While integeral resilent latch members 17 and 19 are shown other latch members can be used to secure the pipe saddle to the end cap 10.

FIG. 2 shows the saddle end cap 10 in a position to be inserted into an open end 30a of an irrigation pipe 30 with the saddle end cap 10 and pipe 30 in axial alignment with each other. In this condition a applying a force to end member 25 forces the saddle end cap into the tubing 30.

FIG. 3 shows the saddle end cap 10 after the saddle end cap has been inserted into the open end of the pipe 30 by the application of a force to the end member 25. In this position the saddle end cap forms a seal on the end of pipe 30 allowing one to dead end the pipe 30 while still providing a subsequent option for forming a branch pipe proximate the end of pipe 30. That is, the end member 25 and platform 24 remain viable for engagement with a pipe saddle when and if desired. Thus, the saddle end cap 10 in a first mode is a stand-alone device for closing and sealing the end of a pipe to prevent leakage from the end of the pipe. In addition, FIG. 3 shows the low profile of the saddle support 24 when the saddle end cap 10 is located in a sealing condition on the end of pipe 30 thereby enabling the saddle end cap to be used similar to an end cap without a saddle support. A further feature of the saddle support 24 is that it can be used as a hook or member for securement of the end of the pipe 30 to a fixed location. For example, if coiled tubing is used the end of the pipe with a saddle end cap can be secured to a fixture to prevent the pipe from coiling as the pipe is unwound from the coil.

The positioning of a saddle support in a fixed location with respect to the side port 22 allows one to form a blind branch attachment within close proximity of the end of the pipe. That is, with the saddle end cap 10 in engagement with pipe 30 as shown in FIG. 3 one can form a branch attachment that aligns with the port 22 even though the port 22 is not visible through the pipe 30. Normally, a pipe saddle would be attached next to an end cap in a pipe or if located proximate the end of the pipe would have been installed with an integral end cap; however, with the present invention a branch attachment can be formed next to the end of the pipe but also in engagement with the side port of the saddle end cap 19 even though the side port is not visible through the end cap by inserting a tap 60 as shown in FIG. 8 therein, which allows securement of the pipe saddle even after an end cap has been installed.

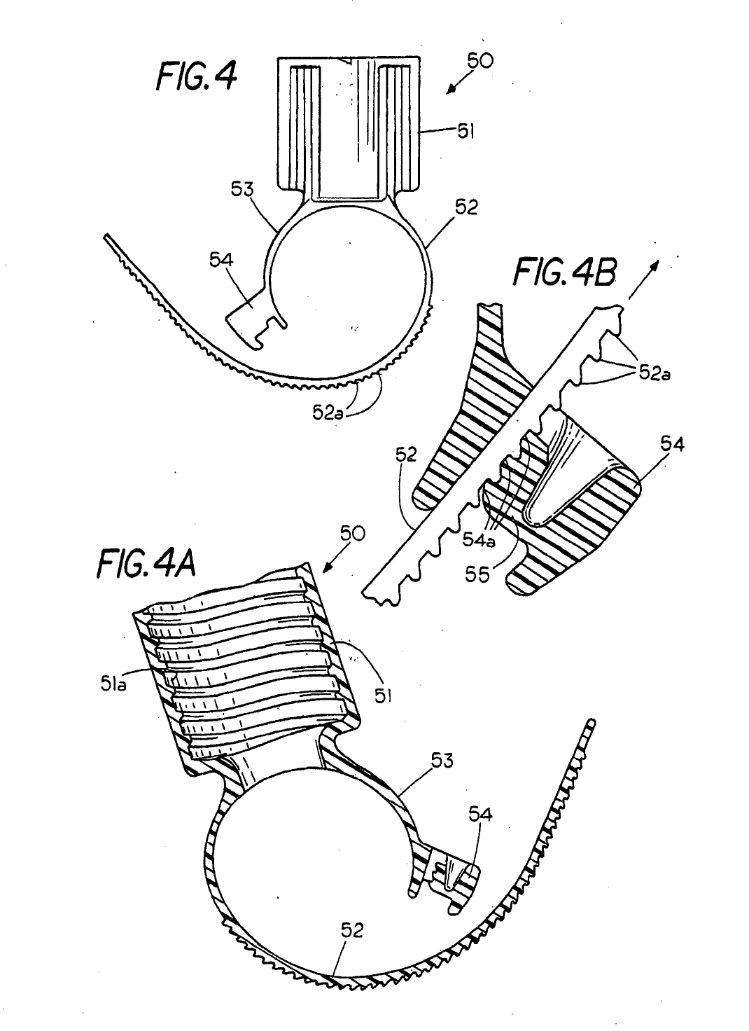

FIG. 4 shows a side view of a pipe saddle 50 having a cylindrical housing 51 and a first flexible band 52 having a plurality of teeth 52a thereon and a second flexible band 53 having a latching hub 54 thereon for forming latching engagement with one or more of the plurality of teeth 52a on the flexible band 52. In operation the flexible band 52 and flexible band 53 are placed around the peripheral region of a pipe such as an irrigation pipe. The multiple teeth 52a provide for accommodation of the pipe saddle to various size pipes.

FIG. 4A shows a sectional view of pipe saddle 50 with housing 51 having internal threads 51a for receiving a tap such as typically shown in U.S. Pat. Nos. 6,510,865 and 6,601,605.

FIG. 4B is an isolated sectional view showing the teeth 52a on the flexible band 52 in engagement with a set of three teeth 54a on a cantilever member 55 that can flex to allow teeth 52a and teeth 54a to slide past each other when band 52 is pulled in the direction of the arrow but prevents teeth 52a and 54a from sliding past each other in the opposite direction thus maintaining the pipe saddle 50 around a pipe with the teeth 54a in engagement with teeth 52a on band 52 as shown in FIG. 4B.

FIG. 5 shows the pipe saddle 50 about to be secured around an irrigation pipe 30 having saddle end cap 10 secured in pipe 30. In the assembly of the saddle and saddle end cap the band 52 of the saddle 50 is extended around pipe 30 and threaded into the hub 54.

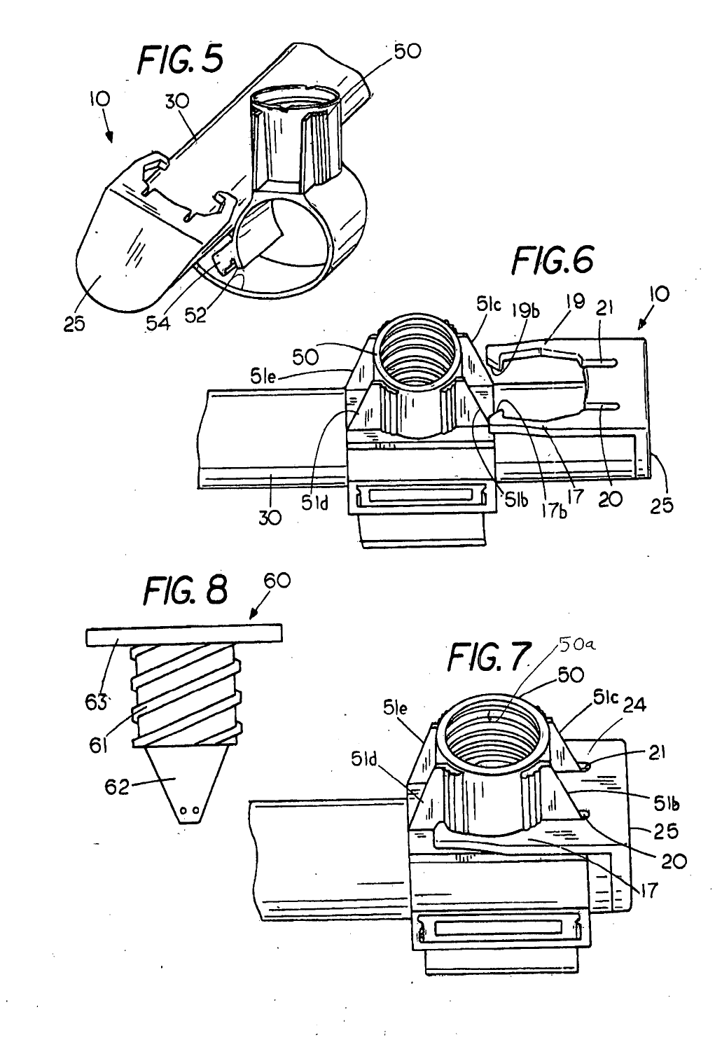

Once the pipe saddle 50 is in circumferential position around the pipe 30, as shown in FIG. 6, the pipe saddle 50 is rotated around the pipe 30 until the guide members 51c and 51b on pipe saddle 50 are in general alignment with the resilient arms 17 and 19. Once in general alignment the pipe saddle 50 is slid axially or longitudinally toward the resilient latch arms 17 and 19 until a guide member 17b on latch arm 17 and a guide edge 19b on the latch arm 19 (see FIG. 3) engage the pipe saddle 50. Once engaged the resilient latch arms 17 and the resilient latch arm 19 spread apart to receive the housing pipe saddle 50 as shown in FIG. 7. In this condition the guides 21 and 20 provide rotationally support for the saddle cap extensions 51c and 51b to hold the housing in a non-rotateable condition with respect to the end cap 10. In addition, once the housing guides 20 and 21 are located in alignment with guide supports the lip 17a on latch arm 17 and the lip 19a on latch arm 19 move into engagement with the saddle 50 to maintain the saddle in the proper axial position. Even though the port 22 is no longer visible (see FIG. 3) the pipe saddle 50 is held in a position where a tap 60 (see FIG. 8) can be inserted through the pipe 30 and into the port 22 in the saddle end cap 10.

FIG. 6 shows a pipe saddle 50 held in an axially slidable condition proximate the saddle end cap 10. As viewed in FIG. 6 the invention comprises a combination end cap/branch attachment including a saddle end cap 10 having a set of ribs in frictional retention on an interior surface of a pipe 30 with the saddle end cap 10 having an end member 25 with a saddle support 24 thereon. The pipe saddle 10 having a housing with guide member 51c and guide member 51b securable in the saddle support 24 to enable forming a branch pipe with the pipe saddle lockable to the saddle end cap through internal port engagement between the engagement of a tap 60 (FIG. 8) and the saddle 50. Pipe saddle 50 also includes identical guide members 51e and 51d on the opposite side thus allowing the pipe saddle 50 to aligned regardless of the positioning of the pipe saddle around the pipe 30. This eliminates the need to reposition the pipe saddle since either orientation of the pipe saddle with respect to the saddle end cap 10 is correct.

FIG. 8 shows a typical tap 60 for insertion into the saddle 50 to form the branch line. Tap 60 includes a gripping region 63 and a male thread section 61 for threaded engagement of female thread in pipe saddle 50 and a cone shaped insert 62 for penetrating though the pipe 30 and into the side port 22 in the saddle thus allowing one to form a branch line proximate the end of the pipe 30. A typical tap is shown and described more fully in U.S. Pat. No. 6,601,605 and is hereby incorporated by reference.

The invention also includes the method of forming a branch attachment or branch line after capping an end of a pipe 30 comprising the steps of: capping a main pipe 30 by inserting a saddle end cap 10 with a saddle support 24 into the end of a main pipe 30 to seal the end of the pipe and prevent flow therefrom. Determining that a branch line needs to be connected to the main pipe either before or after sealing the end of the main pipe. Placing a pipe saddle 50 around the main pipe 30 and securing a saddle band 52 around the main pipe 30. Next one slides the pipe saddle 50 in an axial direction until the pipe saddle is engagement with the saddle support 24. To secure the pipe saddle one latches the pipe saddle 50 to the pipe 30. To complete the branch line one includes the step of directing a tap through pipe 30 and into the port 22 in the saddle end cap 10.

To ensure that the tap is in alignment with the port one includes the step of aligning guide members 51b and 51c on the housing with guides 21 and 20 in the saddle support 24 and in the next step one includes the step of forming a branch line through blind engagement of the tap 60 with the port 22 in the saddle end cap by rotating tap 60 in saddle end cap to cause the end 62 to pierce the pipe 30 and form a portion of the branch line. It should be pointed out that while two guides 21 and 20 are shown a single guide could also be used to align the pipe saddle thereto.

Thus, the drawings illustrate a one-piece end cap 10 for insertion into a tubing 30 comprising: a pipe insert 11 having a central axis 11a with a side port 22 in the pipe insert located intermediate a first open end 11b and second closed end 11c of pipe insert 11. An end member 25 forming a closure on the closed end 11c of the pipe insert 11 with the end member 25 extending radially outward from the pipe insert. A saddle support extending from the end member 25 and a saddle alignment guide 20 or 21 to thereby hold an axially and rotationally displaceable pipe saddle in alignment with the side port 22 to enable blind formation of a branch pipe thereto.

I claim:

1. A one-piece saddle end cap for frictionally inserting into a resilient tubing comprising:
a rigid tube having a central axis;
a plurality of tapered sealing ribs concentrically positioned around an exterior surface of the rigid tube, said rigid tube having a first end with an inlet therein, said ribs having a maximum diameter that is large enough to form an interference fit with an interior surface of a pipe to prevent fluid leaking past said plurality of sealing ribs;
a side port in said rigid tube with said side port located between a first sealing rib of the plurality of tapered sealing ribs and a second sealing rib of the plurality of tapered sealing ribs;
an end member forming a closure on a second end of the rigid tubing, said end member extending radially outward from said rigid tubing;
a saddle support cantilevered from said end member, said saddle support extending along said rigid tube and substantially parallel to the central axis;
a first saddle guide and a second saddle guide located in said saddle support;
a resilient latch arm extending from a first side of said saddle support;
a further resilient latch arm extending from a second side of said saddle support with said resilient latch arm and said further resilient latch arm yieldable to allow insertion and securement of a tube saddle therein, said resilient latch arm and said further resilient latch arm positioned proximate said side port to thereby hold a saddle in alignment with said side port when secured thereto by the resilient latch arm and the further resilient latch arm.

2. The saddle end cap of claim 1 wherein the saddle support comprises a platform.

3. The saddle end cap of claim 2 wherein the first saddle guide and the second saddle guide are located in said platform.

4. The saddle end cap of claim 3 wherein said resilient latch arm and said further resilient latch arm comprise a portion of said platform.

5. The saddle end cap of claim 4 including a saddle located in said saddle support.

6. The saddle end cap of claim 5 wherein the saddle includes a circumferential strap for further securing said end cap to said pipe.

7. A one-piece end cap for insertion into a tubing comprising:
a pipe insert having a central axis;
a side port in said pipe insert, said side port located intermediate a first and second end of said pipe insert;
an end member forming a closure on the second end of the pipe insert, said end member extending radially outward from said pipe insert;
a saddle support extending from said end member; and
a saddle alignment guide to thereby hold an axially and rotationally displaceable pipe saddle in alignment with said side port to enable blind formation of a branch pipe thereto.

8. A combination end cap/branch attachment comprising:
a saddle end cap having a set of ribs for frictional retention on an interior surface of a pipe, said saddle end cap having an end member with a saddle support thereon;
a pipe saddle having a housing, said housing securable in the saddle support to enable forming a branch pipe with the pipe saddle lockable to the saddle end cap through internal port engagement.

9. The combination end cap/branch attachment of claim 8 including a tap securable to the housing.

10. The combination end cap/branch attachment of claim 8 including a set of saddle guides located in said saddle support with each of said set of saddle guides extending in an axial direction.

11. The combination end cap/branch attachment of claim 10 wherein said saddle support cantilevers from said end member.

12. The combination end cap/branch attachment of claim 11 wherein said saddle support includes a set of resilient latch arms for lockingly engaging the housing.

13. The combination end cap/branch attachment of claim 12 wherein said saddle end cap comprises a material harder than a pipe it is to be inserted therein.

14. The method of forming a branch line after capping an end of a pipe comprising the steps of:
capping a pipe by inserting a saddle end cap having a side port located intermeade a first and second end of the saddle end cap and a saddle support into an end of the pipe to prevent flow therefrom;
determining that a branch pipe needs to be connected to the pipe;
placing a pipe saddle around the pipe without removing the saddle end cap;
loosely securing a pipe saddle band around the pipe;
sliding the pipe saddle in an axial direction until the pipe saddle is engagement with the pipe saddle; and
forming a branch line to the side port of the saddle end cap.

15. The method of forming a branch line of claim 14 including the step of sliding and rotating the pipe saddle to bring the pipe saddle into tapping engagement with the saddle support.

16. The method of forming a branch line of claim 15 including latching the pipe saddle to the saddle support prior to forming the branch line to the pipe.

17. The method of forming a branch line of claim 16 including the step of directing a tap through the pipe and into the port in the end cap.

18. The method of forming a branch line of claim 17 including the step of aligning a guide member on the pipe saddle with guide member in the saddle support.

19. The method of forming a branch line of claim 18 wherein the branch is formed through blind engagement with the port in the saddle end cap.

20. The method of forming a branch line of claim 19 including the step of forming the branch line proximate the end member of the saddle end cap.
